(19) United States
(12) Patent Application Publication
(10) Pub. No.: US 2015/0195617 A1
(43) Pub. Date: Jul. 9, 2015

(54) IMAGE DISPLAY APPARATUS, IMAGE PROCESSING METHOD, AND COMPUTER READABLE RECORDING MEDIUM

(71) Applicant: SAMSUNG ELECTRONICS CO., LTD., Suwon-si (KR)

(72) Inventor: Jong-won KWAK, Suwon-si (KR)

(73) Assignee: SAMSUNG ELECTRONICS CO., LTD., Suwon-si (KR)

(21) Appl. No.: 14/501,535

(22) Filed: Sep. 30, 2014

(30) Foreign Application Priority Data
Jan. 6, 2014 (KR) 10-2014-0001456

(51) Int. Cl. H04N 21/462; H04N 21/434; H04N 21/4405; H04N 21/435; H04N 21/643; H04N 21/439; H04N 21/438; H04N 21/4385; H04N 21/4402

(52) U.S. Cl. CPC H04N 21/4622; H04N 21/4385; H04N 21/4341; H04N 21/4348; H04N 21/4405; H04N 21/440218; H04N 21/440263; H04N 21/64322; H04N 21/4398; H04N 21/4383; H04N 21/4355

(57) ABSTRACT

An image display apparatus, an image processing method, and a computer readable recording medium are provided. The image display apparatus includes a signal receiver configured to receive a content image, a signal divider configured to divide the received content image into a video signal, an audio signal, and additional information including information regarding a standard of the content image, and a signal processor configured to determine the standard of the content image based on the information regarding the standard of the content image, and process the divided video signal in accordance with the determined standard.

### CROSS-REFERENCE TO RELATED APPLICATIONS

This application claims priority from Korean Patent Application No. 10-2014-0001456, filed on Jan. 6, 2014, in the Korean Intellectual Property Office, the disclosure of which is incorporated herein by reference in its entirety.

### BACKGROUND

1. Field

Apparatuses and methods consistent with the embodiments relate to an image display apparatus, an image processing method, and a computer readable recording medium, and more particularly, to an image display apparatus which, when an image signal of diverse standards, such as advanced television system committee (ATSC), digital video broadcasting (DVB), or the like, is input to an internet protocol television (IPTV), processes the image signal to be suitable for a corresponding standard and provides a user with the processed image signal, an image processing method, and a computer readable recording medium.

2. Description of the Related Art

Recently, the topic of communication services is ‘all IP’. It means changing the existing services that we use to be operated on the internet. Many things have already changed. Internet phones have become widespread, music has been distributed and consumed over the internet. TVs are no exception. A broadcasting form commonly referred to as cable TV is replaced with the internet, that is, an internet protocol television (IPTV).

In related-art TVs, how to process system information (SI) has been already decided or determined according to a native place of the TV, for example a country or a tuner to select a channel. In other words, when an IPTV is used, a SI module to process a radio frequency (RF) signal is reused, and how to process SI has been already decided. Actually, an IPTV may freely receive advanced television system committee (ATSC) or digital video broadcasting (DVB) streams, but since the ATSC or DVB streams are processed in the decided method, an image signal may be processed unlike a transmitter's intention.

Accordingly, for example, when a transmitter provides a DVB stream while an IPTV application for the American TVs is run, the IPTV may not process the SI properly so that video and audio signals of the received image signal may not be reproduced properly.

For example, with regard to a specific image signal, North American TVs display subtitles or a title of a broadcast program on a lower portion of the screen, but the European TVs may not display them.

### SUMMARY

Exemplary embodiments overcome the above disadvantages and other disadvantages not described above. Also, the embodiments are not required to overcome the disadvantages described above, and an exemplary embodiment may not overcome any of the problems described above.

The embodiments provide an image display apparatus which, when an image signal of diverse standards, such as advanced television system committee (ATSC), digital video broadcasting (DVB), or the like, is input to an internet protocol television (IPTV), processes the image signal to be suitable for or in accordance with a corresponding standard and provides a user with the processed image signal, an image processing method, and a computer readable recording medium.

According to an aspect of the embodiments, an image display apparatus includes a signal receiver configured to receive a content image, a signal divider configured to divide the received content image into a video signal, an audio signal, and additional information including information regarding a standard of the content image, and a signal processor configured to determine the standard of the content image based on the information regarding the standard of the content image, and process the divided video signal in accordance with the determined standard.

The signal receiver may receive an advanced television system committee (ATSC) broadcast signal or a digital video broadcasting (DVB) broadcast signal as the content image.

The signal divider may include a demultiplexer configured to divide the received content image into the video signal, the audio signal, and the additional information.

The signal processor may include a determiner configured to determine the standard based on the divided additional information, and a video decoder configured to decode the divided video signal in accordance with the standard.

The signal processor may include an audio decoder configured to decode the divided audio signal, a video decoder configured to decode the divided video signal, a storage configured to store the divided additional information, a controller configured to store the divided additional information in the storage, determine the standard based on the divided additional information, and control the video decoder to decode the divided video signal in accordance with the determined standard, an audio processor configured to scale the decoded audio signal, a video processor configured to scale the video signal which is decoded in accordance with the determined standard, an audio outputter configured to output the scaled audio signal, and a display configured to output the scaled video signal.

The image display apparatus may further include a user interface configured to receive a user command to select a channel for the broadcast signal. The controller may control the signal receiver to receive the broadcast signal in accordance with the user command.

The additional information may further include information regarding a title of a broadcast program and subtitle information, and the signal processor may combine the processed video signal with at least one of the title and the subtitle information in accordance with the determined standard.

The signal processor may include a switch configured to select a video signal and an audio signal of a broadcast signal requested by a user in response to a plurality of broadcast signals being provided as the content image via one channel, and a plurality of decoders configured to decode the selected video signal and audio signal.

The signal receiver may receive as the content image an image having a different encoding method of the video signal.

According to another aspect of the embodiments, an image processing method includes receiving a content image, dividing the received content image into a video signal, an audio signal, and additional information including information regarding a standard of the content image, and determining the standard of the content image based on the information regarding the standard of the content image, and processing the divided video signal in accordance with the determined standard.

In the operation of receiving the content image, an advanced television system committee (ATSC) broadcast signal or a digital video broadcasting (DVB) broadcast signal may be received as the content image.

The method further includes decoding the divided audio signal, storing the divided additional information, scaling the decoded audio signal, scaling the video signal which is decoded in accordance with the determined standard, outputting the scaled audio signal to an audio outputter, and outputting the scaled video signal to a display.

The method may further include receiving a user command to select a channel for the broadcast signal. In the operation of receiving the content image, the broadcast signal may be received in accordance with the user command.

The additional information may further include information regarding a title of a broadcast program and subtitle information. In the operation of processing the divided video signal in accordance with the determined standard, the processed video signal may be combined with at least one of the title and the subtitle information in accordance with the determined standard.

The operation of processing the divided video signal in accordance with the determined standard may include selecting a video signal and an audio signal of a broadcast signal requested by a user in response to a plurality of broadcast signals being included and provided as the content image via one channel, and decoding the selected video signal and audio signal.

In the operation of receiving the content image, an image having a different encoding method of the video signal may be received as the content image of a different standard.

According to yet another aspect of the embodiments, a computer readable recording medium to run an image processing method is provided, the image processing method including receiving a content image, dividing the received content image into a video signal, an audio signal, and additional information including information regarding a standard of the content image, and determining the standard of the content image based on the information regarding the standard of the content image, and processing the divided video signal in accordance with the determined standard.

In the operation of receiving the content image, an image having a different encoding method of the video signal may be received as the content image of a different standard.

In the operation of receiving the content image, an advanced television system committee (ATSC) broadcast signal or a digital video broadcasting (DVB) broadcast signal may be received as the content image of a different standard.

The additional information may further include information regarding a title of a broadcast program and subtitle information. In the operation of processing the divided video signal in accordance with the determined standard, the processed video signal may be combined with at least one of the title and the subtitle information in accordance with the determined standard.

According to another aspect of the embodiments an image processing method may include dividing an image into signals and information of a standard of the image, determining the standard based on the information, and processing the signals in accordance with the standard.

According to another aspect of the embodiments an image processing method may include receiving an image, determining an image processing standard for the image, and processing the image in accordance with the standard. The method may further include the image being a single channel data structure having an additional information field, an audio signal field and a video signal field and the determining determines the standard using additional information field. The method may also include the determining examining table information of additional information as a basis for determining the standard.

Additional and/or other aspects and advantages of the embodiments will be set forth in part in the description which follows and, in part, will be obvious from the description, or may be learned by practice of the embodiments.

### BRIEF DESCRIPTION OF THE DRAWINGS

The above and/or other aspects of the embodiments will be more apparent by describing certain exemplary embodiments with reference to the accompanying drawings, in which:

FIG. 1A illustrates an image processing system according to an exemplary embodiment;

FIG. 1B is provided to explain different broadcasting standards;

FIG. 2 is a block diagram of a configuration of the image display apparatus shown in FIG. 1A;

FIG. 3 is a block diagram of a configuration of the signal processor shown in FIG. 2;

FIG. 4A illustrates a configuration of data output from the signal receiver shown in FIG. 2;

FIG. 4B is a block diagram of a configuration of the decoder shown in FIG. 3 when data has a data structure shown in FIG. 4A;

FIG. 5 is a flowchart of an image processing method according to a first exemplary embodiment; and

FIG. 6 is a flowchart of an image processing method according to a second exemplary embodiment.

### DETAILED DESCRIPTION

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding. Thus, it is apparent that the exemplary embodiments can be carried out without those specifically defined matters. Also, well-known functions or constructions are not described in detail since they would obscure the embodiments with unnecessary detail.

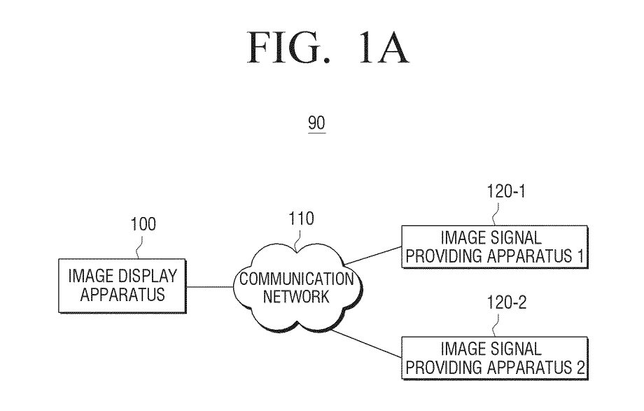

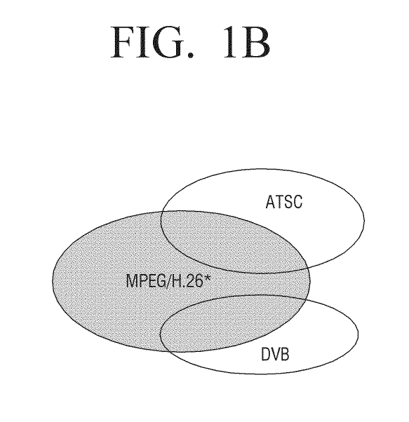

FIG. 1A illustrates an image processing system according to an exemplary embodiment, and FIG. 1B is provided to explain different broadcasting standards.

With reference to FIG. 1A, the image processing system 90 may include an image display apparatus 100, a communication network 110, and a plurality of image signal providing apparatuses 120-1 and 120-2.

The image display apparatus 100 may be a touch screen type image display apparatus, a spontaneous emission display apparatus, such as organic light emitting diodes (OLED), or a light receiving display apparatus, such as a liquid crystal display (LCD) apparatus. In addition, the image display apparatus 100 may be a display apparatus such as a computer or a mobile phone instead of a TV. The light receiving display apparatus may include a separate backlight unit to provide light. The backlight unit may include LEDs.

The image display apparatus 100 according to an exemplary embodiment may be an internet protocol television (IPTV) which receives broadcast signals of diverse broadcast standards, processes the broadcast signal in a suitable method for each standard, and provides the user with images. For example, broadcasting standards include advanced television system committee (ATSC) which is the North American broadcasting standard, and digital video broadcasting (DVB) which is the European broadcasting standard. Each broadcasting standard includes motion picture experts group (MPEG) or H.26* (see FIG. 1B) which is a standard of a broadcasting standard, and further includes a unique area of each broadcasting standard. The unique area indicates an encoding or decoding processing method that each country has autonomously used, and, by extension, a method for displaying additional information, such as a title of a broadcast program or subtitles, on the screen.

In response to receiving the image signal (or a content image or image content) which may be of diverse standards, the image display apparatus 100 may process a unique area of each standard and provide the user with optimal image content. To do so, when providing an image signal in response to the user's request, the image display apparatus 100 firstly determines what is a standard of the image signal. Then, the image display apparatus 100 processes the image signal in accordance with the determined standard. The image signal may include video content, such as movies, as well as broadcast content of a broadcast program.

More specifically, the image display apparatus 100 (FIG. 1A) may receive an image signal from the plurality of image signal providing apparatuses 120-1 and 120-2 according to the user's request. In response to receiving the image signal, the image display apparatus 100 divides the image signal into a video signal, an audio signal, and additional information. The image display apparatus 100 determines what is a standard of the image signal based on the additional information, and processes the video signal in accordance with the determined standard. The additional information may include information regarding a standard, and diverse information, such as subtitles for each country, data information, such as weather information related to the video signal in a case of a broadcast signal, encoding information regarding the video signal, etc. Accordingly, the image display apparatus 100 may determine a standard based on image standard information included in the additional information, decode a broadcast signal using encoding information according to the determination result, and provide the user with the broadcast signal. In this exemplary embodiment, in order to determine the standard of the image signal, data format structure or other diverse information may be used instead of the image standard information. Accordingly, the present embodiments are not limited to the above exemplary embodiment. More detailed description will be provided later.

The communication network 110 includes wired and wireless communication networks. The wired network includes a cable network, and an internet network, such as a public switched telephone network (PSTN). The wireless network includes code division multiple access (CDMA), wideband CDMA (WCDMA), global system for mobile communication (GSM), evolved packet core (EPC), long term evolution (LTE), and wireless broadband internet (WiBro) networks. When the communication network 110 is a wired communication network, an access point may access a telephone exchange office, or when the communication network 120 is a wired communication network, an access point may process data by accessing a serving GPRS support node (SGSN) or a gateway GPRS support node (GGSN) which is operated by a mobile carrier or may process data by accessing diverse repeaters, such as base station transmission (BTS), NodeB, e-NodeB, and the like.

In addition, the communication network 110 may include a small base station (AP), such as femto and pico base stations, which are installed mostly in a building. The femto base station and pico base station are divided according to how many image display apparatuses 100 can access the base station. The AP includes a local area communication module to perform local area communication, such as Zigbee and wireless fidelity (Wi-Fi), with the image display apparatus 100. In the exemplary embodiments, the local area communication may be performed in diverse standards of radio frequency (RF) and ultra wideband (UWB) communication, such as Bluetooth, Zigbee, IrDA, ultra high frequency (UHF), and very high frequency (VHF) as well as wireless fidelity (Wi-Fi). Accordingly, the AP extracts a location of a data packet, sets an optimal communication path for the extracted location, and transmits the data packet to a subsequent apparatus, for example, to the image display apparatus 100 along the set communication path.

The image signal providing apparatuses 120-1 and 120-2 include a broadcasting server operated by a broadcasting station. In addition, the image signal providing apparatuses 120-1 and 120-2 may include a server of an image content provider which provides image content of diverse countries. In this exemplary embodiment, the image signal providing apparatus 1 (120-1) may provide the image display apparatus 100 with a broadcast signal in accordance with the North American ATSC broadcasting standard, and the image signal providing apparatus 2 (120-2) may provide the image display apparatus 100 with a broadcast signal in accordance with the European DVB broadcasting standard. The image signal providing apparatuses 120-1 and 120-2 may provide broadcast content, that is, a broadcast signal of a program, of a broadcasting channel selected by the user on the image display apparatus 100. The image signal providing apparatuses 120-1 and 120-2 may process a video signal or insert additional information for an independent method of each country as shown in FIG. 1B.

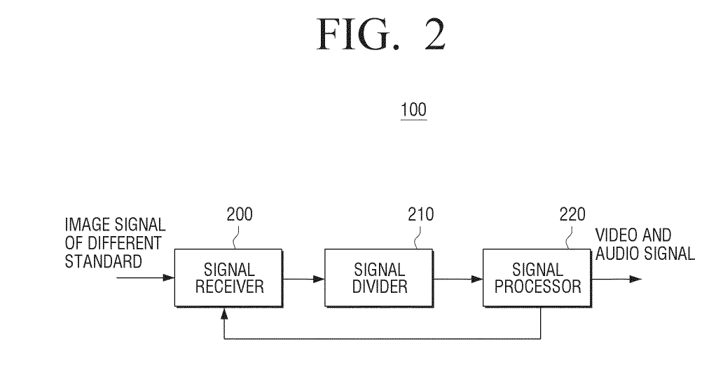

FIG. 2 is a block diagram of a configuration of the image display apparatus 100 shown in FIG. 1A.

With reference to FIG. 2 and with reference to FIG. 1A, the image display apparatus 100 may include a signal receiver 200, a signal divider 210, and a signal processor 220 in part or in whole.

Including the components in part or in whole indicates excluding some components such as the signal receiver 200 or integrating some components such as the signal receiver 200 into another component such as the signal divider 210. For sufficient understanding of the embodiments, the image display apparatus 100 is explained to include all of the components.

The signal receiver 200 receives an image signal of a different standard (or of a different data format). To do so, the signal receiver 200 may access the external image signal providing apparatus 120-1 or 120-2 over the communication network 110 according to control of the signal processor 220 and receive an image signal. Although not shown in the drawings, the signal receiver 200 may also receive an image signal from a separate player, such as a Blu-ray disk player and a digital video disk (DVD) player. Based on this feature, the signal receiver 200 may include a first receiver to receive an image signal over a global positioning system (GPS) or a terrestrial wave, and a second receiver to receive an image signal of a player. For example, the first receiver may perform further operations such as tuning, demodulation, and A/D conversion than the second receiver.

The signal divider 210 includes a demultiplexer. Using the demultiplexer, the signal divider 210 divides an image signal transmitted from the signal receiver 200 into a video signal, an audio signal, and additional information. When the signal receiver 200 includes two tuners, the signal divider 210 may include a plurality of demultiplexers. In this case, the signal divider 210 may further include a switch to select one demultiplexer. The additional information may include data information such as weather or an advertisement, subtitle information for subtitle broadcasting of each country, encoding information regarding an encoded video signal, and the like.

The signal processor 220 determines what is a standard of the received image signal, based on the additional information divided by the signal divider 210. Subsequently, the signal processor 220 processes and outputs the video signal of the received image signal using a suitable method as a result of determination. For example, when the signal processor 220 determines that the received image signal is an image signal of the ATSC standard based on the additional information, the signal processor 220 decodes the video signal in a suitable method for the ATSC standard. At this time, the signal processor 220 may decode the video signal using encoding information included in the additional information. In addition, the signal processor 220 may combine a title or subtitles of the broadcast program with the video signal in accordance with the ATSC standard. For example, in a related-art image display apparatus which is preset to display subtitles in the ATSC standard, when an image signal of a DVB standard is received, the subtitles may not be displayed on the screen, but the image display apparatus 100 according to the exemplary embodiment may display the subtitles.

The signal processor 220 may acquire encoding information from additional information included in an image signal, or acquire the encoding information through another path. Accordingly, the exemplary embodiments do not limit how to acquire the encoding information. For example, when an image signal is provided through a terrestrial wave, encoding information may be provided through a wire path, such as the internet.

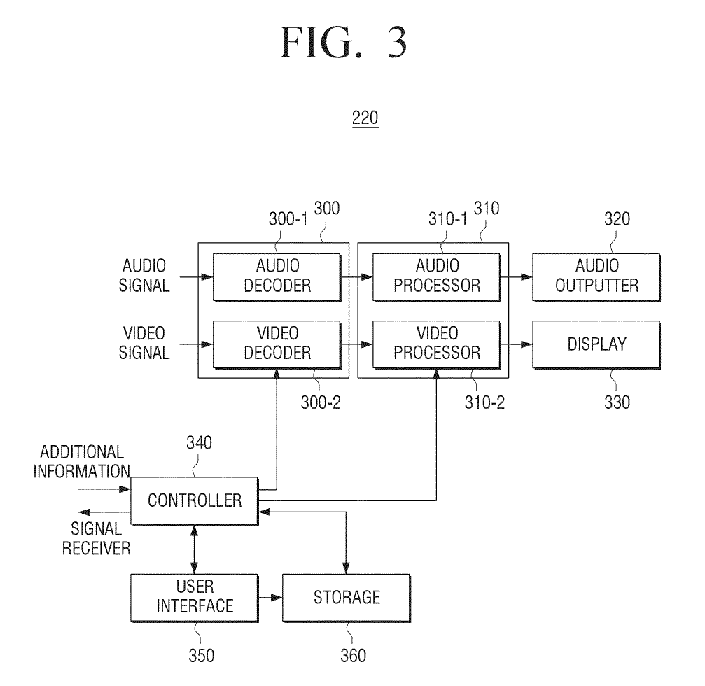

FIG. 3 is a block diagram of a configuration of the signal processor 220 shown in FIG. 2.

With reference to FIG. 3 together with FIG. 2, the signal processor 220 may include a decoder 300, an audio/video processor 310, an audio outputter 320, a display 330, a controller 340 which may be a computer, a user interface 350, and storage 360, such as a memory, in part or in whole. Including the components in part or in whole has been described above.

The decoder 300 includes an audio decoder 300-1 and a video decoder 300-2. The audio decoder 300-1 decodes an input audio signal, and the video decoder 300-2 decodes an input video signal. When decoding a video signal, the video decoder 300-2 may produce the video signal with reference to encoding information or decoding information stored in the storage 360 according to the control of the controller 340.

In other words, when the input video signal is a video signal encoded in the ATSC standard, the video decoder 300-2 decodes the video signal in or using a suitable method for the ATSC standard based on information which the controller 340 provides with reference to a lookup table of the ATSC standard stored in the storage 360. In the case of the DVB standard, the video decoder 300-2 decodes the video signal with reference to a lookup table of the DVB standard and outputs the restored video signal.

The audio/video processor 310 includes an audio processor 310-1 and a video processor 310-2. The audio processor 310-1 removes noise from the decoded audio signal. The video processor 310-2 performs bit-conversion for RGB pixel information to be suitable for a resolution of the display 330. In addition, the video processor 310-2 combines the decoded video signal with additional information stored in the storage 360, for example subtitle information. Based on this feature, the video processor 310-2 may include a mixer. In this case, the video processor 310-2 combines the decoded video signal with the additional information to be suitable for the ATSC or DBV standard. For example, in the ATSC standard, when subtitles are set to be displayed on a lower portion of the screen, the video processor 310-2 displays subtitles on the lower portion of the screen according to additional information regarding this.

The audio outputter 320 is a terminal which is connected to a speaker, and may include a speaker. Through the speaker, the audio outputter 320 outputs audio in synchronization with a video signal, that is, an image displayed on the display 330.

The display 330 includes a display panel. Through the display panel, the display 330 displays on the screen a video signal processed in accordance with the standard by the video processor 310-2.

The controller 340 stores additional information divided by the signal divider 310 shown in FIG. 2 in the storage 360. Using the additional information, the controller 340 determines in which standard a currently input video signal is or has been generated. Based on this feature, the controller 340 may include a determiner. For example, when an input video signal is a video signal of the ATSC standard, the controller 340 may process additional information to be suitable for the ATSC standard, and inform the video decoder 300-2 of corresponding information, and when an input video signal is a video signal of the DVB standard, the controller 340 may process additional information to be suitable for the DVB standard, and inform the video decoder 300-2 of corresponding information. Processing additional information to be suitable for a specific standard may indicate differentiating a processing sequence of the additional information.

When the storage 360 pre-stores encoding or decoding information in a lookup table form to process a video signal input in the ATSC or DVB standard, the controller 340 may select a lookup table of a specific standard, and process the video signal. Since the controller 340 may process information in diverse methods in association with the video decoder 300-2 and the storage 360 as described above, the exemplary embodiments are not limited to the aforementioned method.

The user interface 350 receives a user command and provides the controller 340 with the user command. For example, when the user interface 350 receives a signal, such as channel selection information from a remote control apparatus such as a remote control, and transmits the signal to the controller 340. The user interface 350 may include diverse buttons, such as a power button.

The storage 360 stores additional information provided by the controller 340. Subsequently, the storage 360 outputs the stored additional information according to control the controller 240. Since the additional information may include information of diverse features, the storage 360 may sort the additional information according to the features and store the additional information. For example, subtitle information and encoding information may be divided and stored, and encoding information may be stored in a different lookup table form according to the ATSC or DVB standard.

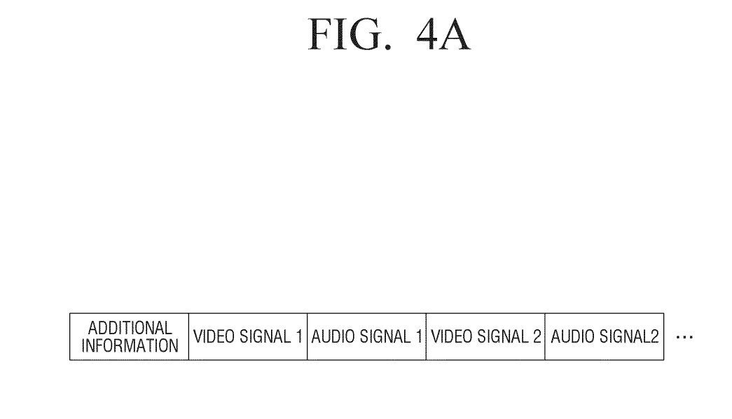

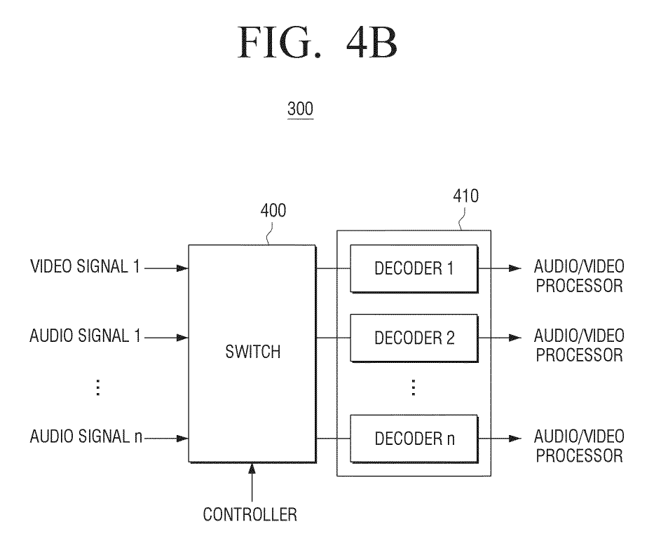

FIG. 4A illustrates a configuration of data output from by the signal receiver 200 shown in FIG. 2, and FIG. 4B is a block diagram of a configuration of the decoder 300 shown in FIG. 3 when data has a data structure shown in FIG. 4A

With reference to FIGS. 4A and 4B together with FIG. 2, for example, the signal receiver 200 shown in FIG. 2 may receive an image signal with a data structure shown in FIG. 4A which may include an additional information field along with audio and video signal fields of different programs. In other words, the signal receiver 200 may receive video signals of a plurality of broadcast programs via one channel.

In this case, a switch 400 may select a path to decode only a video signal and an audio signal of a broadcast program that the user wants. For example, when the user selects video signal 2 of a broadcast program that the user wants, the controller 340 shown in FIG. 3 selects audio signal 2 together and outputs video signal 2 and audio signal 2 to each decoder.

Subsequently, a plurality of decoders 410 decode video signal 2 and audio signal 2 respectively, and transmit the decoded signals to the audio/video processor 310.

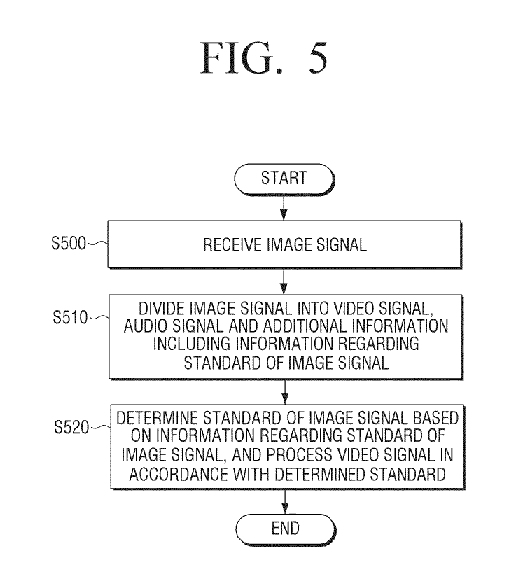

FIG. 5 is a flowchart of an image processing method according to a first exemplary embodiment.

With reference to FIG. 5 together with FIG. 1 for convenience of description, the image display apparatus 100 receives an image signal (or a content image) (S500). The image signal (or an image) is an image signal of a different standard, including a broadcast signal of a broadcasting standard such as ATSC or DVB, and image content such as a video produced in a specific country. In other words, the image display apparatus 100 may determine whether the image signal is an image signal including only PSI data, ATSC data, or DVB data.

For example, when the image display apparatus 100 is interlocked with a player, such as a DVD player, and reproduces image content produced in Europe, the image display apparatus 100 determines an image standard, for example data format structure, of the image content and processes the received image in a suitable method according to the result of determination.

Subsequently, the image display apparatus 100 divides the received image signal into a video signal, an audio signal, and additional information including information regarding the standard of the image signal (S510).

Subsequently, the image display apparatus 100 determines the standard of the received image signal based on the additional information, and more specifically, based on the information regarding the standard, and the image display apparatus 100 processes the video signal in accordance with the determined standard (S520). Processing the video signal in accordance with the determined standard may indicate decoding the video signal to be suitable for the determined standard or combining the additional information with the video signal decoded to be suitable for the determined standard.

During the above process, the image display apparatus 100 may store the divided additional information in a separate memory, and call and use the stored additional information. The additional information may be PSI data, ATSC data, or DVB data. The PSI data is a common table, which may be a program association table (PAT) and a program map table (PMT). The ATSC data may be a master guide table (MGT) and a virtual channel table (VCT). The DVB data may be a service description table (SDT) and a network information table (NIT). These tables may be used in the determining as the basis to determine each standard.

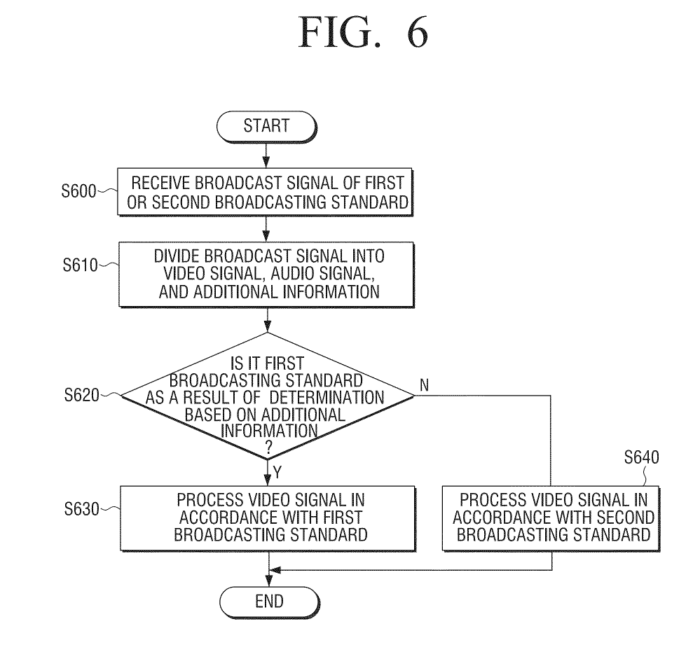

FIG. 6 is a flowchart of an image processing method according to a second exemplary embodiment.

With reference to FIG. 6 together with FIG. 1 for convenient description, when receiving a broadcast signal, the image display apparatus 100 receives a broadcast signal of a first or second broadcasting standard (S600). The first or second broadcasting standard is a broadcast signal of different broadcasting standards, which may be one of ATSC, DVB, and integrated service digital broadcasting (ISDB) which is the Japanese broadcasting standard.

Subsequently, the image display apparatus 100 divides the received broadcast signal into a video signal, an audio signal, and additional information including standard information (S610).

Subsequently, the image display apparatus 100 determines whether the currently input broadcast signal is the first broadcasting standard or the second broadcasting standard based on the additional information (S620).

In response to the currently input broadcast signal being the first broadcasting standard, the image display apparatus 100 processes the video signal to be suitable for the first broadcasting standard and displays the video signal on the screen (S630), and in response to the currently input broadcast signal being the second broadcasting standard, the image display apparatus 100 processes the video signal to be suitable for the second broadcasting standard and displays the video signal on the screen (S640). Processing the video signal to be suitable for the first or second broadcasting standard may indicate processing data or information appropriately for an independent portion that each country has as well as a standard that the two broadcasting standards share.

Although the components of the exemplary embodiments are described to be combined into one or to be operated by a combination, the embodiments are not limited thereto. Within the scope of the purpose of the embodiments, one or more components may be selectively combined and operated. In addition, each of the components may be implemented with independent computer type hardware or a portion of or all of the components may be selectively combined and be implemented with a computer program having a program module which performs a portion of or all of the functions combined in one or more pieces of hardware. The codes and the code segments which compose the computer program may easily be inferred by those skilled in the art. The computer program is stored in a non-transitory computer readable medium, and is read and run by one or more computers so that the exemplary embodiments may be implemented.

The non-transitory computer readable medium is a medium which does not store data temporarily such as a register, cash, and memory but stores data semi-permanently and is readable by devices. More specifically, the computer program may be stored in non-transitory computer readable media such as compact disks (CDs), digital video disks (DVDs), hard disks, Blu-ray disks, universal serial buses (USBs), memory cards, and read-only memory (ROM).

The foregoing exemplary embodiments and advantages are merely exemplary and are not to be construed as limiting the embodiments. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An image display apparatus, comprising:
a signal receiver configured to receive a content image;
a signal divider configured to divide the content image into a video signal, an audio signal and additional information including information regarding a standard of the content image; and
a signal processor configured to determine the standard of the content image based on the information regarding the standard of the content image, and process the video signal in accordance with the standard determined.

2. The image display apparatus as claimed in claim 1, wherein the signal receiver receives one of an advanced television system committee (ATSC) broadcast signal and a digital video broadcasting (DVB) broadcast signal as the content image.

3. The image display apparatus as claimed in claim 1, wherein the signal divider comprises a demultiplexer configured to divide the content image into the video signal, the audio signal, and the additional information.

4. The image display apparatus as claimed in claim 1, wherein the signal processor comprises:
a determiner configured to determine the standard based on the additional information; and
a video decoder configured to decode the video signal in accordance with the standard.

5. The image display apparatus as claimed in claim 1, wherein the signal processor comprises:
an audio decoder configured to decode the audio signal to produce a decoded audio signal;
a video decoder configured to decode the video signal;
storage configured to store the additional information;
a controller configured to store the additional information in the storage, determine the standard based on the additional information, and control the video decoder to decode the video signal in accordance with the determined standard;
an audio processor configured to scale the decoded audio signal to produce a scaled audio signal;
a video processor configured to scale the video signal to produce a scaled video signal which is decoded in accordance with the determined standard;
an audio outputter configured to output the scaled audio signal; and
a display configured to output the scaled video signal.

6. The image display apparatus as claimed in claim 5, further comprising:
a user interface configured to receive a user command to select a channel for a broadcast signal,
wherein the controller controls the signal receiver to receive the broadcast signal in accordance with the user command.

7. The image display apparatus as claimed in claim 1, wherein the additional information further includes information regarding a title of a broadcast program and subtitle information, and
the signal processor combines the video signal with at least one of the title and the subtitle information in accordance with the determined standard.

8. The image display apparatus as claimed in claim 1, wherein the signal processor comprises:
a switch configured to select a requested video signal and a requested audio signal of a broadcast signal requested by a user in response to a plurality of broadcast signals being provided as the content image via a single channel; and
a plurality of decoders configured to decode the requested video signal and requested audio signal.

9. The image display apparatus as claimed in claim 1, wherein the signal receiver receives as the content image an image having a different encoding method from the encoding method of the video signal.

10. An image processing method, comprising:
receiving a content image;
dividing the content image into a video signal, an audio signal, and additional information including information regarding a standard of the content image; and
determining the standard of the content image based on the information regarding the standard of the content image, and processing the video signal in accordance with the standard.

11. The method as claimed in claim 10, wherein in the operation of receiving the content image, one of an advanced television system committee (ATSC) broadcast signal and a digital video broadcasting (DVB) broadcast signal is received as the content image.

12. The method as claimed in claim 10, wherein further comprising:
decoding the audio signal;
storing the additional information;
scaling the audio signal to produce a scaled audio signal;
scaling the video signal to produce a scaled video signal which is decoded in accordance with the determined standard;
outputting the scaled audio signal to an audio outputter; and
outputting the scaled video signal to a display.

13. The method as claimed in claim 12, further comprising:
receiving a user command to select a channel for a broadcast signal,
wherein in the operation of receiving the content image, the broadcast signal is received in accordance with the user command.

14. The method as claimed in claim 10, wherein the additional information further includes information regarding a title of a broadcast program and subtitle information, and
in the operation of processing the video signal in accordance with the standard, the video signal is combined with at least one of the title and the subtitle information in accordance with the standard.

15. The method as claimed in claim 10, wherein the operation of processing the video signal in accordance with the standard comprises:
selecting a requested video signal and a requested audio signal of a broadcast signal requested by a user in response to a plurality of broadcast signals being included and provided as the content image via; and
decoding the requested video signal and the requested audio signal.

16. The method as claimed in claim 10, wherein in the operation of receiving the content image, an image having a different encoding method than the encoding method of the video signal is received as the content image of a different standard.

17. A computer readable recording medium to run an image processing method, the image processing method comprising:
receiving a content image;
dividing the content image into a video signal, an audio signal, and additional information including information regarding a standard of the content image; and
determining the standard of the content image based on the information regarding the standard of the content image, and processing the video signal in accordance with the determined standard.

18. The computer readable recording medium as claimed in claim 17, wherein in the operation of receiving the content image, an image having a different encoding method than the encoding method of the video signal is received as the content image of a different standard.

19. The computer readable recording medium as claimed in claim 17, wherein in the operation of receiving the content image, one of an advanced television system committee (ATSC) broadcast signal and a digital video broadcasting (DVB) broadcast signal is received as the content image of a different standard.

20. The computer readable recording medium as claimed in claim 17, wherein the additional information further includes information regarding a title of a broadcast program and subtitle information, and
in the operation of processing the video signal in accordance with the standard, the video signal is combined with at least one of the title and the subtitle information in accordance with the standard.

21. An image processing method, comprising:
dividing an image into signals and information of a standard of the image;
determining the standard based on the information; and
processing the signals in accordance with the standard.

22. An image processing method, comprising:
receiving an image;
determining an image processing standard for the image; and
processing the image in accordance with the standard.

23. The method as claimed in claim 22, wherein the image comprises a single channel data structure comprising an additional information field, an audio signal field and a video signal field and the determining determines the standard using additional information field.

24. The method as claimed in claim 22, wherein the determining examines table information of additional information as a basis for determining the standard.
